(19) United States
(12) Patent Application Publication
(10) Pub. No.: US 2008/0111875 A1
(43) Pub. Date: May 15, 2008

(54) MEDIUM SUPPLYING MECHANISM, LIQUID EJECTING DEVICE, AND RECORDING DEVICE

(75) Inventors: Yutaka Nagashima, Matsumoto-shi (JP); Junya Kato, Matsumoto-shi (JP); Hiroshi Shiohara, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/558,317

(22) Filed: Nov. 9, 2006

(51) Int. Cl. B41J 2/01; B65H 1/00

(52) U.S. Cl. 347/104; 271/171

(57) ABSTRACT

A medium supplying mechanism that supplies medium to be supplied with one end of each medium serving as a reference includes a medium supporting unit having a plurality of extendable and contractable supporting portions that are disposed in steps and that support the medium. Supporting widths and dispositions of the supporting portions of the respective steps are determined so that the supporting portions are capable of supporting the medium having the largest size among the medium with a central line in a widthwise direction of the medium having the largest size serving as a symmetry axis.

### BACKGROUND

1. Technical Field

The present invention relates to a medium supplying mechanism that supplies a medium to be supplied with one end of the medium to be supplied serving as a reference, a liquid ejecting device including the medium supplying mechanism, and a recording device including the medium supplying mechanism.

2. Related Art

An inkjet printer, which is a generally used recording device, has a sheet feeder at the upper portion of its back side and a sheet discharger at the lower portion of its front side. In addition, the inkjet printer has a paper support at the sheet feeder and a stacker at the sheet discharger. The paper support supports in layers sheets in an inclined state. The stacker is used to stack in layers the sheets in a horizontal state. Since the paper support needs to support sheets of various sizes of up to, for example, an A2 size in Japanese Industrial Standard (JIS) the paper support is formed in a multi-step structure that allows the paper support to be drawn out and to be accommodated. Support portions disposed in steps of the paper support that has a multi-step structure are formed so that, the supporting widths become narrower with increasing height of the support portions. Each support portion is accommodated in substantially the center of its lower support portion (refer to JP-A-2003-267560).

In general, the inkjet printer is formed so that a sheet is fed with one end of the sheet serving as a reference. However, since the above-described related paper support is such that each support portion of its associated step is disposed at substantially the center of the its lower support portion, the paper support asymmetrically supports the left and right sides of the sheet, particularly, when the sheet is large. For this reason, an unsupported portion of the sheet may be bent by, for example, its own weight.

### SUMMARY

An advantage of the invention is that it provides a medium supplying mechanism including a medium supporting unit capable of stably supporting medium to be supplied having different sizes, a liquid ejecting device including the medium supplying mechanism, and a recording device including the medium supplying mechanism.

To this end, according to a first aspect of the invention, there is provided a medium supplying mechanism that supplies medium to be supplied with one end of each medium serving as a reference. The medium supplying mechanism includes a medium supporting unit having a plurality of extendable and contractable supporting portions that are disposed in steps and that support the medium. Supporting widths and dispositions of the supporting portions of the respective steps are determined so that the supporting portions are capable of supporting the medium having the largest size among the medium with a central line in a widthwise direction of the medium having the largest size serving as a symmetry axis. This makes it possible to stably support even media to be supplied having different sizes, so that they can be supplied with high precision.

It is desirable that the medium supporting unit be such that the supporting portion of a predetermined one of the steps is disposed so as to be shifted in the widthwise direction with respect to the other supporting portion or supporting portions. This makes it possible to symmetrically support in the widthwise direction the media to be supplied, so that the medium can be substantially prevented from, for example, being bent. It is also desirable that the supporting portions of a second of the steps and onwards all be capable of being accommodated in the supporting portion of a first of the steps, and be rotatable around one end of the supporting portion of the first step as an axis. This makes it possible for the medium supporting unit to be compactly accommodated in the medium supplying mechanism. It is also desirable that the medium supplying mechanism further include a first load receiving unit and a second load receiving unit, which are disposed at a rotary shaft of the supporting portion of the first step. The first load receiving unit receives a load of the medium supporting unit, and the second load receiving unit receives a load of the first load receiving unit. This makes it possible to gently accommodate the medium supporting unit in and gently draw out the medium supporting unit from the medium supplying mechanism.

To this end, according to a second aspect of the invention, there is provided a liquid ejecting device that ejects liquid onto an ejection medium. The liquid ejecting device includes any one of the aforementioned medium supplying mechanisms. According to a third aspect of the invention, there is provided a recording device that performs recording on a recording medium. The recording device includes any one of the above-described medium supplying mechanisms. Therefore, it is possible to provide a liquid ejecting device or a recording device that provides each of the aforementioned advantages.

### BRIEF DESCRIPTION OF THE DRAWINGS

The invention will be described with reference to the accompanying drawings, wherein like numbers reference like elements.

FIG. 1 is a perspective view of an entire external structure of an inkjet printer, which is a recording device, according to an embodiment of the invention, as seen obliquely from the front.

FIG. 2 is a perspective view of the entire external structure of the printer shown in FIG. 1, as seen obliquely from the back.

FIG. 3 is a schematic perspective view of an internal structure of the printer shown in FIG. 1.

FIG. 4 is a schematic sectional side view of the internal structure of the printer shown in FIG. 1.

FIG. 5 is a first perspective view of a first paper support of the printer shown in FIG. 1 and the vicinity thereof, as seen from the front.

FIG. 6 is a second perspective view of the first paper support of the printer shown in FIG. 1 and the vicinity thereof, as seen from the front.

FIG. 7 is a perspective view of FIG. 6, as seen from the back.

FIG. 8 is a plan view of a layout of each support portion of the first paper support shown in FIG. 5.

FIG. 9 is a perspective view of a portion of the first paper support shown in FIG. 5 at and near its rotary shaft.

### DESCRIPTION OF EXEMPLARY EMBODIMENT

An embodiment of the invention will be described with reference to the drawings. The embodiment that is described below does not limit the inventions related to claims. In addition, all combinations of features described in the embodiment are not necessarily required for solving the related problems by the invention.

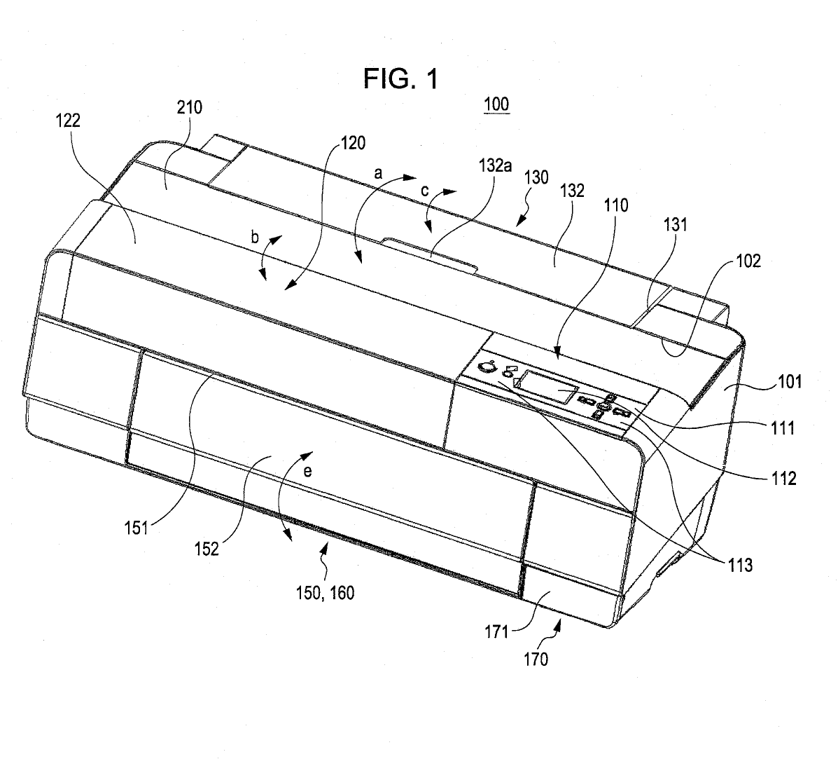

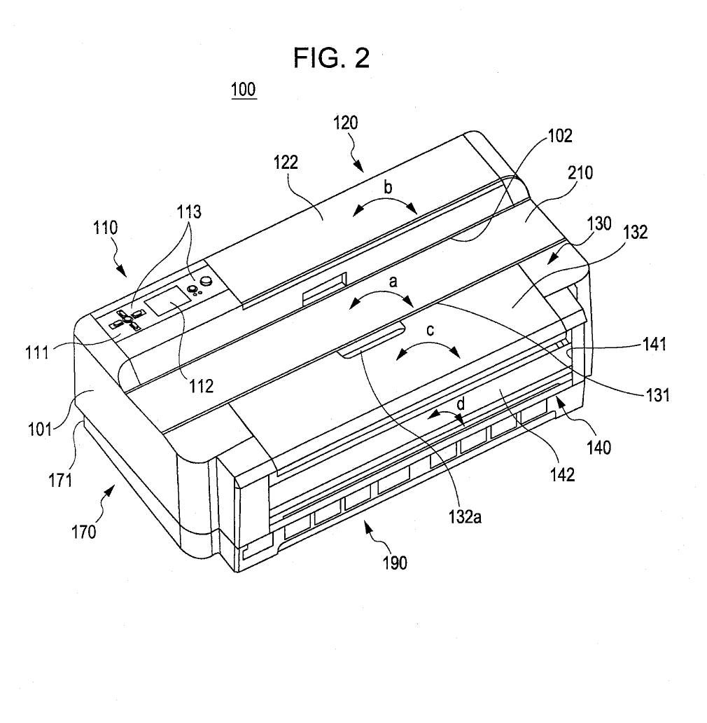

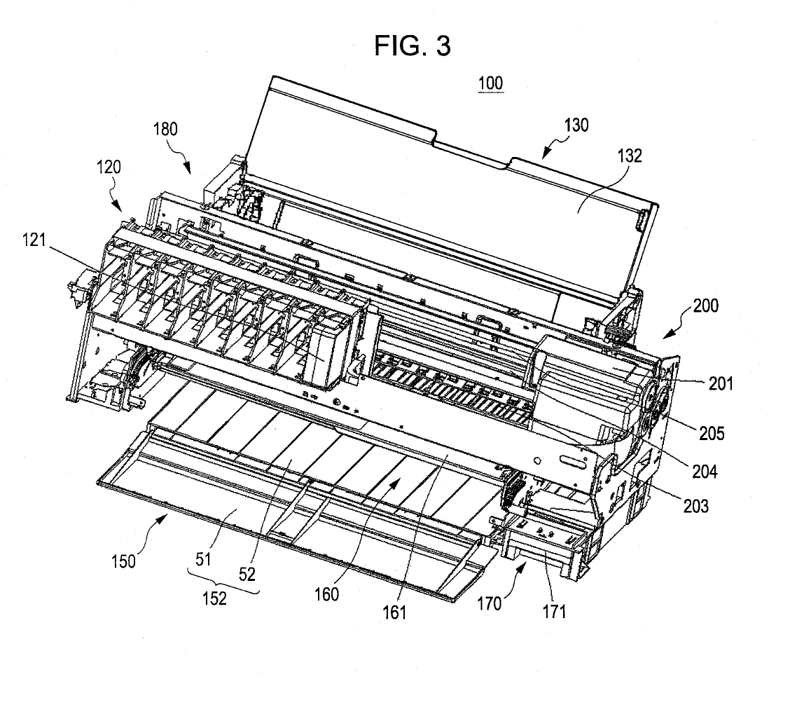

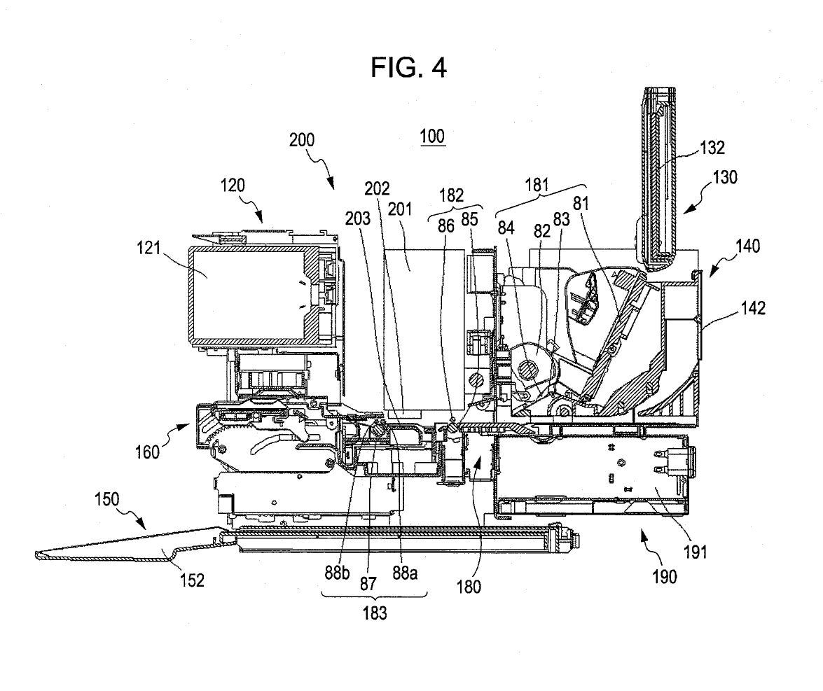

FIGS. 1 and 2 are perspective views of an entire external structure of an inkjet printer, which is a recording device, according to an embodiment of the invention, as seen obliquely from the front and back, respectively. FIG. 3 is a schematic perspective view of an internal structure of the printer, and FIG. 4 is a schematic sectional side view of the internal structure of the printer. An inkjet printer 100 can perform a recording operation on a cut paper (hereunder referred to as “sheet” corresponding to a medium to be supplied, a medium to which liquid is ejected, or a recording medium) with ink (liquid). The sheet has, for example, an A4 size, an A3-nobi size, or an A2 size of JIS, is a postcard, or has an L size/2L size.

As shown in FIGS. 1 and 2, the entire inkjet printer 100 is covered with a substantially rectangular parallelepipedic housing 101. An operating unit 110 is disposed at the right front side of the upper surface (shown in FIG. 1) of the housing 101, and a cartridge accommodating unit 120 is disposed at the left front side of the upper surface (shown in FIG. 1) of the housing 101. A first rear sheet-feed unit (medium supplying mechanism) 130, which is a characteristic portion of the invention, is disposed at the back side of the upper surface (shown in FIG. 1) of the housing 101, and a second rear sheet-feed unit 140 is disposed at the back side (shown in FIG. 2) of the housing 101. A sheet-discharge unit 150 and a front sheet-feed unit 160 are disposed at the front side (shown in FIG. 1) of the housing 101, and a waste ink recovering unit 170 is disposed at the right side of the front surface (shown in FIG. 1) of the housing 101. A sheet transporting unit 180 (shown in FIGS. 3 and 4), a controlling unit 190 (shown in FIGS. 2 and 4), and a recording unit 200 (shown in FIGS. 3 and 4) are disposed in the interior of the inkjet printer 100.

As shown in FIGS. 1 and 2, a rectangular opening 102 is formed in a portion of the top surface of the housing 101 surrounded by the operating unit 110, the cartridge accommodating unit 120, and the first rear sheet-feed unit 130. The opening 102 is covered with a substantially rectangular flat printer cover 210. The printer cover 210 is mounted so as to be rotatable in the directions of an illustrated double-headed arrow around a rotary shaft as a center at its back end. By uncovering the opening 102 by lifting the printer cover 210, a user can easily, for example, maintain the internal mechanisms, such as the sheet transporting unit 180 and the recording unit 200, through the opening 102.

As shown in FIGS. 1 and 2, the operating unit 110 includes a substantially rectangular panel 111 and a liquid crystal panel 112 that is disposed at substantially the center of the operating panel 111 and that displays, for example, an operation state. Buttons 113 (for a power system that turns on/off power, an operating system that is operated to, for example, set an edge of a sheet or perform ink flushing, and a processing system that, for example, processes an image) are provided on both sides of the liquid crystal panel 112. Since the user can operate the buttons 113 while checking the liquid crystal panel 112, it is possible to prevent an erroneous operation.

As shown in FIGS. 1 and 2, the cartridge accommodating unit 120 accommodates ink cartridges 121 (shown in FIGS. 3 and 4), which store ink of print colors (nine print colors in the embodiment), so as to be insertable and removable from the cartridge accommodating unit 120. The cartridge accommodating unit 120 is covered with a cartridge cover 122 that is L-shaped in cross section. The cartridge cover 122 is mounted so as to be rotatable in the directions of an illustrated double-headed arrow b around a rotary shaft as a center at its back end. By uncovering the cartridge accommodating unit 120 by lifting the cartridge cover 122, the user can, for example, easily replace the ink cartridges 121, thereby making it possible to increase working efficiency.

The first rear sheet-feed unit 130 is for automatic sheet feeding (ASF). As shown in FIGS. 1 and 2, the first rear sheet-feed unit 130 has a first paper support (medium supporting unit) 132 having a four-step structure that has a function of opening and closing an upwardly extending rectangular first sheet-feed opening 131 and a function of supporting one or a plurality of sheets to be fed. The first paper support 132 is mounted so as to be rotatable in the directions of a double-headed arrow c around a rotary shaft as a center at its back end. The sheet or sheets that are fed by the first rear sheet-feed unit 130 are relatively thin (for example, plain sheets or photography sheets having a thickness on the order of from 0.08 mm to 0.27 mm). The first paper support 132 will be described in detail later.

The second rear sheet-feed unit 140 is for manual sheet feed. As shown in FIG. 2, the second rear sheet-feed unit 140 has a second paper support 142 having a two-step structure that has a function of opening and closing a backwardly extending rectangular second sheet-feed opening 141 and a function of supporting one sheet to be fed. The second paper support 142 is mounted so as to be rotatable in the directions of a double-headed arrow d around a rotary shaft as a center at its lower end. The one sheet to be fed by the second rear sheet-feed unit 140 is a sheet having a thickness that cannot be fed at a transportation angle in the first rear sheet-feed unit 130 (for example, a art sheet or a dedicated sheet having a thickness on the order of from 0.29 mm to 0.48 mm). Since the first rear sheet-feed unit 130 is for automatic sheet feeding (ASF), it picks up a sheet by a sheet-feed roller 82. When dust sticks to and accumulates on the sheet-feed roller 82, the sheet-feed roller 82 may slide and, thus, cause improper sheet feed. Therefore, even for sheets where dust tends to be produced (such as velvet fine art paper having a thickness on the order of 0.48 mm, and ultra smooth fine art paper having a thickness on the order of 0.46 mm), it is necessary to manually feed them by the second rear sheet-feed unit 140.

Prior to using the inkjet printer 100, the user places his/her finger on the illustrated top portion of the second paper support 142 and pushes down the second paper support 142 to draw out the multi-step portion, thereby completing the setting. Therefore, it is not necessary to perform, for example, storage or controlling operation required when a removable paper support is used. In addition, since the second paper support 142 is one having a multi-step structure, it can reliably support sheets to be fed having various sizes. Further, after using the inkjet printer 100, the second sheet-feed opening 141 can be covered by pushing and closing the multi-step portion of the second paper support 142. Therefore, it is possible to prevent entry of dust into the body of the printer and to compactly accommodate the second paper support 142.

As shown in FIG. 1, the sheet-discharge unit 150 includes a stacker 152 having a two-step structure. The stacker 152 includes a first stacker portion 51 and a second stacker portion 52 (shown in FIG. 3) having a function of covering and uncovering a forwardly extending rectangular sheet-discharge opening 151 and a function for stacking one or a plurality of sheets that are discharged. The first stacker portion 51 is mounted so as to be rotatable in the directions of an illustrated double-headed arrow e around a rotary shaft as a center at the front end of the second stacker portion 52. The second stacker portion 52 is mounted so that it can protrude and be accommodated by moving in parallel obliquely vertically with respect to the sheet-discharge opening 151.

Prior to using the inkjet printer 100, the user places his/her finger on the top portion of the first stacker portion 51 and rotates the first stacker portion 51 towards the front to uncover the sheet-discharge opening 151. Then, the user holds the front end of the first stacker portion 51 with his/her finger and draws it out, so that the second stacker portion 52 is moved in parallel obliquely upward to make it protrude, thereby completing the setting. Therefore, it is not necessary to perform, for example, the storage or controlling operation required when a removable stacker is used. Since the stacker 152 is one having a multi-step structure, sheets to be discharged having various sizes can be reliably stacked in layers or the sheets that have been subjected to recording are always discharged from the front side. Therefore, the user can easily take out the sheets. After using the inkjet printer 100, it is possible to accommodate the second stacker portion 52 by moving it in parallel obliquely downward as a result of pushing in the front end of the first stacker portion 51 with one's hand. In addition, it is possible to cover the sheet-discharge opening 151 by placing the hand on the first stacker portion 51 and rotating the first stacker portion 51 towards the back. Therefore, it is possible to prevent entry of dust into the body of the printer and to compactly accommodate the stacker 152.

The front sheet-feed unit 160 is for manual sheet feed. As shown in FIG. 3, it includes a sheet-feed tray 161 disposed above the stacker portion 152 in the sheet-discharge opening 151. The sheet-feed tray 161 is provided so as to be movable horizontally with respect to the sheet-discharge opening 151. Sheets that are fed by the front sheet-feed unit 160 are those that are relatively thick that cannot be bent when transporting them (for example, mat boards having a thickness on the order of 1.2 mm).

Prior to using the inkjet printer 100, the user lightly pushes in the front end of the sheet-feed tray 161 to disengage a stopper of the sheet-discharge tray 161, thereby causing the sheet-feed tray 161 to protrude from the sheet-discharge opening 151. After using the inkjet printer 100, by lightly pushing in the front end of the sheet-discharge tray 161, the stopper of the sheet-discharge tray 161 is engaged to accommodate the sheet-feed tray 161 in the sheet-discharge opening 151. Therefore, it is possible to improve the space utilization of the sheet-feed tray 161.

As shown in FIGS. 1 to 3, the waste ink recovering unit 170 accommodates a waste ink tank 171 (which stores, for example, waste ink) so that the waste ink tank 171 can be inserted into and removed from the waste ink recovering unit 170. The waste ink tank 171 stores, for example, the waste ink that is exhausted when cleaning a recording head 202 or replacing any of the ink cartridges. When the waste ink tank 171 is filled with, for example, the waste ink, the user draws out the ink tank 171 and inserts another waste ink tank 171. This makes it easier to replace the waste ink tank 171.

As shown in FIGS. 3 and 4, the sheet transporting unit 180 is provided from the first rear sheet-feed unit 130 and the second rear sheet-feed unit 140 to the sheet-discharge unit 150. It includes an automatic sheet-feed mechanism 181, a transporting mechanism 182, and a sheet-discharge mechanism 183. As shown in FIG. 4, the automatic sheet-feed mechanism 181 includes, for example, a hopper 81, the sheet-feed roller 82, a retard roller 83, and a sheet-returning lever 84. The hopper 81 lifts up sheets that are supported by the first paper support 132 to feed them. The sheet-feed roller 82 takes out the sheets lifted by the hopper 81. The retard roller 83 separates one at a time the sheets that are double-fed by the sheet-feed roller 82. The sheet-returning lever 84 returns the remaining sheets separated by the retard roller 83 to the hopper 81.

The hopper 81 is formed with a flat shape so as to allow sheets to be placed thereupon, and is disposed substantially parallel to a back wall. The lower end of the hopper 81 is positioned near the sheet-feed roller 82, and the upper end thereof is disposed so as to be positioned near the top portion of the back wall. A compression spring (not shown) having one end mounted to the back wall has its other end mounted to the back surface at the lower end side of the hopper 81. The hopper 81 is disposed so that the lower end side of the hopper 81 is rotatable around its upper end side as a center by expansion and compression of the compression spring.

The sheet-feed roller 82 is formed into a D shape having a portion of its cross section cut out, and is disposed near the lower end of the hopper 81. The sheet-feed roller 82 rotates intermittently so as to frictionally feed the sheets that are lifted by the hopper 81. The retard roller 83 is disposed so that it can contact the sheet-feed roller 82, and is such as to frictionally separate only the topmost sheet from the lower sheets below the topmost sheet when the sheets are double-fed by the sheet-feed roller 82. The sheet-returning lever 84 is formed in the shape of a pawl and is disposed near the sheet-feed roller 82. The lower sheets that have been separated by the retard roller 83 are caught by the pawl to return them to the hopper 81.

As shown in FIG. 4, the transporting mechanism 182 includes, for example, a sheet-feed roller 85 and a driven roller 86, which transport sheets in a sub-scanning direction in synchronism with a recording operation. The sheet-feed roller 85 is disposed upstream from a platen 203 in the direction of sheet transportation. The sheet-feed roller 85 and the driven roller 86 nip a sheet that is fed by the sheet-feed roller 82 to send the sheet to the platen 203.

As shown in FIG. 4, the sheet-discharge mechanism 183 includes, for example, a sheet-discharge roller 87, a first serrated roller 88a, and a second serrated roller 88b. The first serrated roller 88a is disposed downstream from the platen 203 in the direction of sheet transportation, and the second serrated roller 88b and the sheet-discharge roller 87 are disposed downstream from the first serrated roller 88a in the direction of sheet transportation so as to oppose each other. The sheet that has passed the platen 203 is first discharged from the first serrated roller 88a and is, then, nipped by the second serrated roller 88b and the sheet-discharge roller 87 to discharge the sheet onto the stacker 152. The first serrated roller 88a and the second serrated roller 88b are held by the same holding member (not shown).

As shown in FIG. 4, the controlling unit 190 includes a main substrate 191 that constitutes a printer controller. The main substrate 191 has mounted thereto controlling elements and storage elements, such as a CPU, ROM, RAM, or ASIC, none of which are shown, and various other types of circuit elements. The controlling unit 190 controls, for example, the recording unit 200 and the sheet transporting unit 180 of a print engine.

As shown in FIG. 4, the recording unit 200 includes, for example, a carriage 201 that moves in a main scanning direction in synchronism with a recording operation, the recording head 202 that discharges ink in synchronism with the recording operation, and the platen 203 that holds the sheet in a flat state during the recording. As shown in FIG. 3, the carriage 201 passes through a carriage guide shaft 204 above the platen 203 and is connected to a carriage belt 205. When the carriage belt 205 is operated by a carriage motor (not shown), the carriage 203 is moved by the movement of the carriage belt 205 and is guided along the carriage guide shaft 204, so that it reciprocates.

As shown in FIG. 4, the recording head 202 is mounted to the carriage 201 so that a predetermined interval is provided between the recording head 202 and the platen 203. It can discharge ink of two types of black, such as photo-black and matte black, and ink of seven colors, yellow, cyan, light cyan, magenta, light magenta, gray, and red. In other words, the recording head 202 includes a nozzle plate having a pressure generating chamber and a nozzle connected to the pressure generating chamber. By storing the ink in the pressure generating chamber and applying a predetermined pressure thereto, an ink droplet having a controlled size is discharged towards the sheet from the nozzle. The platen 203 is disposed between the sheet-feed roller 85 and the sheet-discharge roller 87 so as to oppose the recording head 202, and supports a surface of the sheet that is being transported. Next, the first paper support 132, which is a characteristic portion of the invention, will be described in more detail with reference to the drawings.

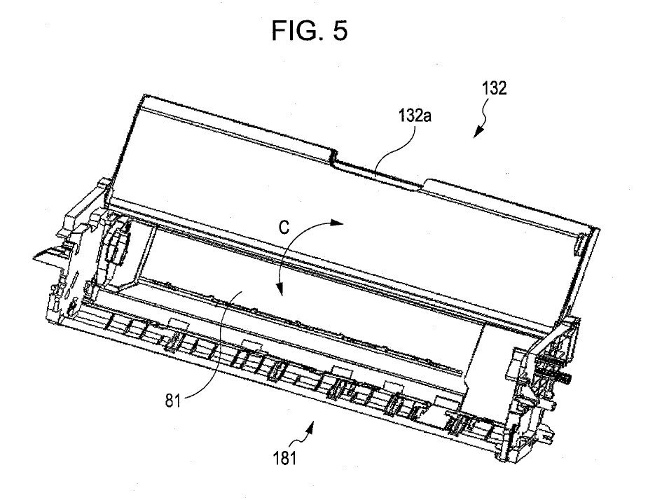

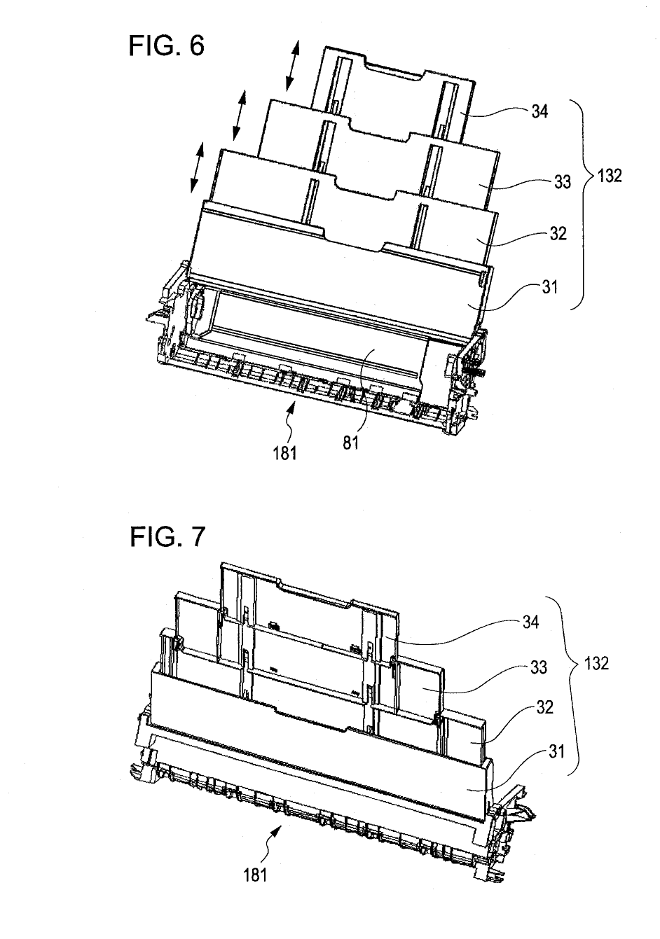

FIGS. 5 and 6 are perspective views of the first paper support 132 and the vicinity thereof, as seen from the front. FIG. 7 is a perspective view of the first paper support 132 and the vicinity thereof, as seen from the back. As shown in FIG. 5, the first paper support 132 is axially supported so as to be rotatable in the directions of a double-headed arrow c, at the top portion of the hopper 81 of the automatic sheet-feed mechanism 181. In addition, as shown in FIGS. 6 and 7, the first paper support 132 includes a first supporting portion 31, a second supporting portion 32, a third supporting portion 33, and a fourth supporting portion 34, which support the back surfaces of sheets. The first paper support 132 is not limited to one having a four-step structure, so that it may have a plurality of steps of three or less or five or more.

The first supporting portion 31 is hollow and has the form of a flat box. The second supporting portion 32 has a supporting width that is smaller than that of the first supporting portion 31, is flat, and is disposed so as to be vertically slidable in the first supporting portion 31. The third supporting portion 33 has a supporting width that is smaller than that of the second supporting portion 32, is flat, and is disposed so as to be vertically slidable at the back side of the second supporting portion 32. The fourth supporting portion 34 has a supporting width that is smaller than that of the third supporting portion 33, is flat, and is disposed so as to be vertically slidable at the back side of the third supporting portion 33. Accordingly, the second supporting portion 32 can be accommodated in and drawn out from the first supporting portion 31, the third supporting portion 33 can be accommodated in and drawn out from the second supporting portion 32, and the fourth supporting portion 34 can be accommodated in and drawn out from the third supporting portion 33.

Here, as stated in the related art, the inkjet printer 100 feeds a sheet with one end of the sheet being a reference. Therefore, in the related paper support in which each supporting portion is accommodated in substantially the center of its lower supporting portion, when, in particular, a large-sized sheet is to be supported, its left and right sides are asymmetrically supported. This may cause an unsupported portion of the sheet to be bent by, for example, its own weight. To overcome this problem, the supporting portions 31, 32, 33, and 34 of the first paper support 132 according to the embodiment have the following layout structure.

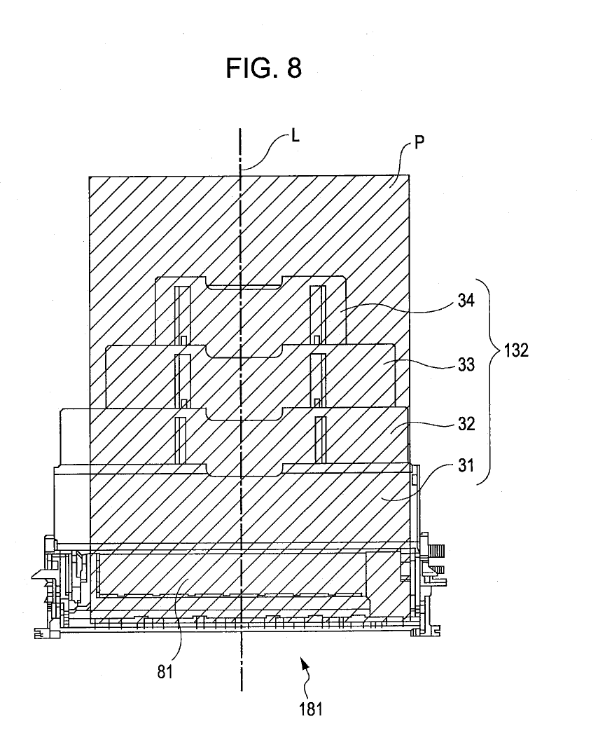

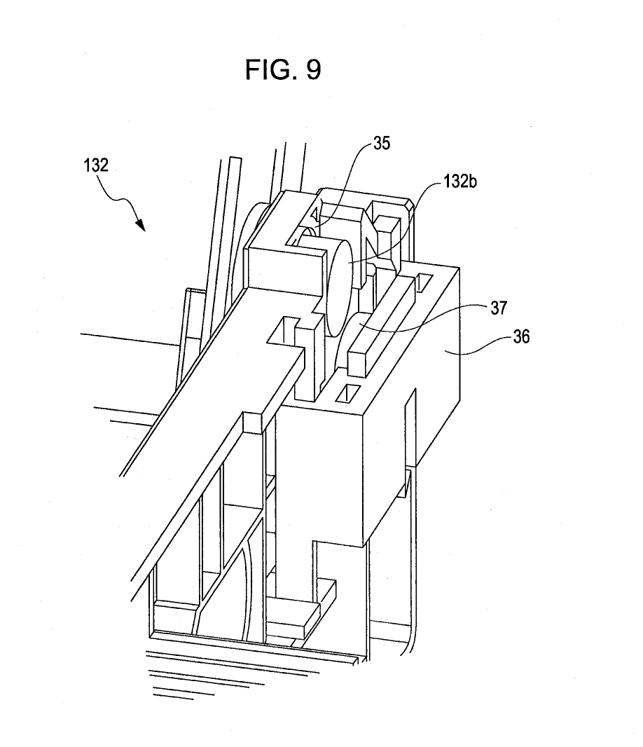

FIG. 8 is a plan view of the layout of the supporting portions 31, 32, 33, and 34 of the first paper support 132. The layout of the supporting portions 31, 32, 33, and 34 of the first paper support 132 is determined with reference to an A2-size sheet P of JIS, which is a sheet of the largest size that can be used in the inkjet printer 100 according to the embodiment.

That is, the supporting widths of the respective supporting portions 31, 32, and 33 are adjusted so that substantially the entire surface of a sheet having a size that is less than the A2-size (or corresponding size) sheet P of JIS is supported from the first supporting portion 31 to the third supporting portion 33 and the weight of the sheet can be spread over the supporting portions 31, 32, and 33. Then, the supporting width of the fourth supporting portion 34 is determined so that the A2-size (or corresponding size) sheet P of JIS can be supported with a central line L in the widthwise direction serving as a symmetry axis while the left and right sides of the sheet P are symmetrically flexed when the fourth supporting portion 34 is also used.

By such determination described above, in the first paper support 132 according to the embodiment, the third supporting portion 33 is shifted in the widthwise direction. This makes it possible to reliably support in a stable orientation sheets to be fed having various sizes, so that they can be fed with high precision. Even if the sheets to be fed of various sizes are left supported on the first paper supporting portion 132 for a long time, it is possible to substantially limit deformation of the sheets, so that they can be prevented from being improperly fed.

Prior to using the inkjet printer 100, as shown in FIG. 5, the user places his/her finger in an opening 132a of the first paper supporting portion 132 to rotate the first paper support 132 upward and to uncover the first sheet-feed opening 131. As shown in FIG. 6, the second supporting portion 32 is drawn out from the first supporting portion 31, the third supporting portion 33 is drawn out from the second supporting portion 32, and the fourth supporting portion 34 is drawn out from the third supporting portion 33. Therefore, it is unnecessary to perform a mounting operation or a removal operation, which are carried out when a removable paper support is used, with respect to the body of the printer. Consequently, it is possible to facilitate setting.

After using the inkjet printer 100, the fourth supporting portion 34 is pushed into the third supporting portion 33, the third supporting portion 33 is pushed into the second supporting portion 32, and the second supporting portion 32 is pushed into the first supporting portion 31. Then, the first paper support 132 is rotated downward to cover the first sheet-feed opening 131. Therefore, since the first sheet-feed opening 131 can be covered, it is possible to prevent entry of dust into the body of the printer. In addition, since the first paper support 132 can be compactly accommodated, it is possible to reduce the space occupied by the first paper support 132. It is not necessary to perform, for example, the storage or controlling operation required when a removable paper support is used. Therefore, for example, the first paper support 132 will not be lost. The supporting portions 31, 32, 33, and 34 may optionally be drawn out depending upon the size of sheets being used.

Since the above-described first paper support 132 has a multi-step structure, it tends to be large and heavy. Therefore, it tends to be closed with great force. To overcome this problem, the first paper support 132 is designed in the following way. The design will be described with reference to the drawings.

FIG. 9 is a perspective view of a portion of the first paper support 132 at and near its rotary shaft. At a rotary shaft 132b of the first paper support 132, a rack (second load receiving unit) 35 is formed, and a damper (first load receiving unit) 37 held by a damper holder 36 is disposed. According to this structure, when the user closes the first paper support 132, the load of the first paper support 132 is received by the damper 37, so that the first paper support 132 can be moved gently. On the other hand, when the user opens the first paper support 132, the load generated at the damper 37 is received by the rack 35, so that extra force is not required. Therefore, the user can smoothly open and close the first paper support 132.

Although the inkjet printer is described as an example of the recording device, the invention may be applied to any device as long as the device is a recording device, such as a facsimile or a copying machine. Instead of to the recording device, the invention may be applied to a liquid ejecting device that ejects liquid corresponding to purpose of use, rather than ink, onto a medium from a liquid ejecting head, and that adheres the liquid to the medium. Examples thereof include a device including, for example, a coloring-material ejection head (used in manufacturing a color filter of, for example, a liquid crystal display), an electrode-material (conductive material) ejection head (used in forming an electrode of, for example, an organic EL display or a surface-emitting display (FED)), a living organic-material ejection head (used in biochip manufacturing), or a sample ejection head serving as a precision pipet.

What is claimed is:

1. A medium supplying mechanism that supplies medium to be supplied with one end of each medium serving as a reference, the medium supplying mechanism comprising:
a medium supporting unit having a plurality of extendable and contractable supporting portions that are disposed in steps and that support the medium,
wherein supporting widths and dispositions of the supporting portions of the respective steps are determined so that the supporting portions are capable of supporting the medium having the largest size among the medium with a central line in a widthwise direction of the medium having the largest size serving as a symmetry axis.

2. The medium supplying mechanism according to claim 1, wherein the medium supporting unit is such that the supporting portion of a predetermined one of the steps is disposed so as to be shifted in the widthwise direction with respect to the other supporting portion or supporting portions.

3. The medium supplying mechanism according to claim 1, wherein the supporting portions of a second of the steps and onwards are all capable of being accommodated in the supporting portion of a first of the steps, and are rotatable around one end of the supporting portion of the first step as an axis.

4. The medium supplying mechanism according to claim 3, further comprising a first load receiving unit and a second load receiving unit, which are disposed at a rotary shaft of the supporting portion of the first step, the first load receiving unit receiving a load of the medium supporting unit, the second load receiving unit receiving a load of the first load receiving unit.

5. A liquid ejecting device that ejects liquid onto an ejection medium, the liquid ejecting device comprising:
the medium supplying mechanism of claim 1.

6. A recording device that performs recording on a recording medium, the recording device comprising:
the medium supplying mechanism of claim 1.
